(19) United States
(12) Patent Application Publication
(10) Pub. No.: US 2022/0022554 A1
(43) Pub. Date: Jan. 27, 2022

(54) DIAGNOSTIC SYSTEM AND METHOD

(71) Applicant: NICOVENTURES TRADING LIMITED, London (GB)

(72) Inventor: Siddhartha JAIN, (US)

(21) Appl. No.: 17/309,282

(22) PCT Filed: Oct. 3, 2019
(86) PCT No.: PCT/GB2019/052787

§ 371 Date: May 14, 2021

(51) Int. Cl. A24F 40/65; A24F 40/53; A24F 40/90

(52) U.S. Cl. CPC A24F 40/65; A24F 40/90; A24F 40/53

(57) ABSTRACT

A diagnostic system for an electronic vapor provision system (EVPS) includes a detection processor adapted to detect one or more of a plurality of predetermined misuse events; a diagnostic processor adapted to perform, in response to detection of a predetermined misuse event, at least one corresponding system diagnostic; and an output processor adapted to indicate the result of the or each performed diagnostic to a user.

### PRIORITY CLAIM

The present application is a National Phase entry of PCT Application No. PCT/GB2019/052787, filed Oct. 3, 2019, which claims priority from GB Patent Application No. 1818741.9, filed Nov. 16, 2018, each of which is hereby fully incorporated herein by reference.

### TECHNICAL FIELD

The present disclosure relates to a diagnostic system and method.

### BACKGROUND

Electronic vapor provision systems (EVPSs), such as e-cigarettes and other aerosol delivery systems, are complex devices comprising a power source sufficient to vaporize a volatile material, together with control circuitry, a heating element and typically a liquid payload. Some EVPSs also comprise communication systems and/or computing capabilities.

The device is then used intermittently but frequently, all-day and every day, in close proximity to the user.

This level of use may result in accidents that can result in breakage or malfunction. Similarly a degree of misuse could also result in breakage or malfunction.

It is desirable to limit such breakage or malfunction.

### SUMMARY

The present disclosure seeks to alleviate or mitigate this problem.

In a first aspect, a diagnostic system for an electronic vapor provision system is provided in accordance with the disclosure.

In another aspect, a mobile communication device is provided in accordance with the disclosure.

In another aspect, a diagnostic method for an electronic vapor provision system is provided in accordance with the disclosure.

In another aspect, a diagnostic method for use with a mobile communications device is provided in accordance with the disclosure.

Further respective aspects and features of the disclosure are defined in the appended claims.

### BRIEF DESCRIPTION OF THE DRAWINGS

Embodiments of the present disclosure will now be described by way of example with reference to the accompanying drawings, in which:

FIG. 1 is a schematic diagram of an e-cigarette in accordance with embodiments of the present disclosure.

FIG. 2 is a schematic diagram of a control unit of an e-cigarette in accordance with embodiments of the present disclosure.

FIG. 3 is a schematic diagram of a processor of an e-cigarette in accordance with embodiments of the present disclosure.

FIG. 4 is a schematic diagram of an e-cigarette in communication with a mobile terminal in accordance with embodiments of the present disclosure.

FIG. 5 is a schematic diagram of a cartomizer of an e-cigarette.

FIG. 6 is a schematic diagram of a vaporizer or heater of an e-cigarette.

FIG. 7 is a schematic diagram of a mobile terminal in accordance with embodiments of the present invention.

FIG. 8 is a flow diagram of a diagnostic method for an electronic vapor provision system in accordance with embodiments of the present disclosure.

FIG. 9 is a flow diagram of a diagnostic method for use with a mobile communications device in accordance with embodiments of the present disclosure.

### DETAILED DESCRIPTION

A diagnostic system and method are disclosed. In the following description, a number of specific details are presented in order to provide a thorough understanding of the embodiments of the present disclosure. It will be apparent, however, to a person skilled in the art that these specific details need not be employed to practice the present disclosure. Conversely, specific details known to the person skilled in the art are omitted for the purposes of clarity where appropriate.

By way of background explanation, electronic vapor provision systems, such as e-cigarettes and other aerosol delivery systems, generally contain a reservoir of liquid which is to be vaporized, typically nicotine (this is sometimes referred to as an “e-liquid”). When a user inhales on the device, an electrical (e.g. resistive) heater is activated to vaporize a small amount of liquid, in effect producing an aerosol which is therefore inhaled by the user. The liquid may comprise nicotine in a solvent, such as ethanol or water, together with glycerine or propylene glycol to aid aerosol formation, and may also include one or more additional flavors. The skilled person will be aware of many different liquid formulations that may be used in e-cigarettes and other such devices.

The practice of inhaling vaporized liquid in this manner is commonly known as ‘vaping’.

An e-cigarette may have an interface to support external data communications. This interface may be used, for example, to load control parameters and/or updated software onto the e-cigarette from an external source. Alternatively or additionally, the interface may be utilized to download data from the e-cigarette to an external system. The downloaded data may, for example, represent usage parameters of the e-cigarette, fault conditions, etc. As the skilled person will be aware, many other forms of data can be exchanged between an e-cigarette and one or more external systems (which may be another e-cigarette).

In some cases, the interface for an e-cigarette to perform communication with an external system is based on a wired connection, such as a USB link using a micro, mini, or ordinary USB connection into the e-cigarette. The interface for an e-cigarette to perform communication with an external system may also be based on a wireless connection. Such a wireless connection has certain advantages over a wired connection. For example, a user does not need any additional cabling to form such a connection. In addition, the user has more flexibility in terms of movement, setting up a connection, and the range of pairing devices.

Throughout the present description the term “e-cigarette” is used; however, this term may be used interchangeably with electronic vapor provision system, aerosol delivery device, and other similar terminology.

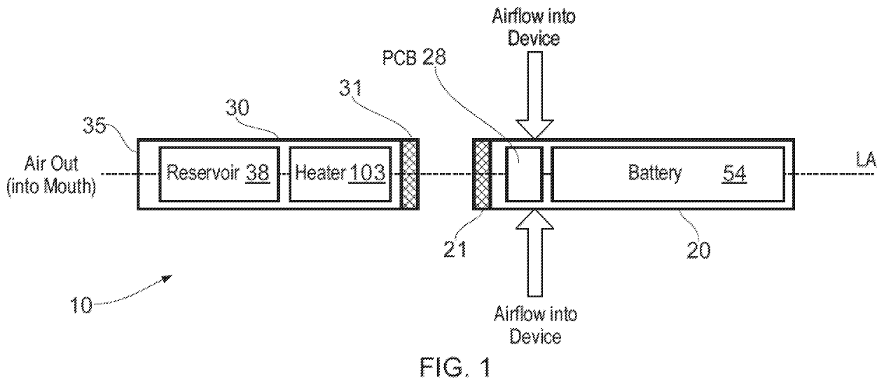

FIG. 1 is a schematic (exploded) diagram of an e-cigarette 10 in accordance with some embodiments of the disclosure (not to scale). The e-cigarette comprises a body or control unit 20 and a cartomizer 30. The cartomizer 30 includes a reservoir 38 of liquid, typically including nicotine, a heater 36, and a mouthpiece 35. The e-cigarette 10 has a longitudinal or cylindrical axis which extends along the center-line of the e-cigarette from the mouthpiece 35 at one end of the cartomizer 30 to the opposing end of the control unit 20 (usually referred to as the tip end). This longitudinal axis is indicated in FIG. 1 by the dashed line denoted LA.

The liquid reservoir 38 in the cartomizer may hold the (e-)liquid directly in liquid form, or may utilize some absorbing structure, such as a foam matrix or cotton material, etc., as a retainer for the liquid. The liquid is then fed from the reservoir 38 to be delivered to a vaporizer comprising the heater 36. For example, liquid may flow via capillary action from the reservoir 38 to the heater 36 via a wick (not shown in FIG. 1).

In other devices, the liquid may be provided in the form of plant material or some other (ostensibly solid) plant derivative material. In this case the liquid can be considered as representing volatiles in the material which vaporize when the material is heated. Note that devices containing this type of material generally do not require a wick to transport the liquid to the heater, but rather provide a suitable arrangement of the heater in relation to the material to provide suitable heating.

It will also be appreciated that forms of payload delivery other than a liquid may be equally considered, such as heating a solid material (such as processed tobacco leaf) or a gel. In such cases, the volatiles that vaporize provide the active ingredient of the vapor/aerosol to be inhaled. It will be understood that references herein to ‘liquid’, ‘e-liquid’ and the like equally encompass other modes of payload delivery, and similarly references to ‘reservoir’ or similar equally encompass other means of storage, such as a container for solid materials.

The control unit 20 includes a re-chargeable cell or battery 54 to provide power to the e-cigarette 10 (referred to hereinafter as a battery) and a printed circuit board (PCB) 28 and/or other electronics for generally controlling the e-cigarette.

The control unit 20 and the cartomizer 30 are detachable from one another, as shown in FIG. 1, but are joined together when the device 10 is in use, for example, by a screw or bayonet fitting. The connectors on the cartomizer 30 and the control unit 20 are indicated schematically in FIG. 1 as 31B and 21A respectively. This connection between the control unit and cartomizer provides for mechanical and electrical connectivity between the two.

When the control unit is detached from the cartomizer, the electrical connection 21A on the control unit that is used to connect to the cartomizer may also serve as a socket for connecting a charging device (not shown). The other end of this charging device can be plugged into a USB socket to re-charge the battery 54 in the control unit of the e-cigarette. In other implementations, the e-cigarette may be provided (for example) with a cable for direct connection between the electrical connection 21A and a USB socket.

The control unit is provided with one or more holes for air inlet adjacent to PCB 28. These holes connect to an air passage through the control unit to an air passage provided through the connector 21A. This then links to an air path through the cartomizer 30 to the mouthpiece 35. Note that the heater 36 and the liquid reservoir 38 are configured to provide an air channel between the connector 31B and the mouthpiece 35. This air channel may flow through the center of the cartomizer 30, with the liquid reservoir 38 confined to an annular region around this central path. Alternatively (or additionally) the airflow channel may lie between the liquid reservoir 38 and an outer housing of the cartomizer 30.

When a user inhales through the mouthpiece 35, air is drawn into the control unit 20 through the one or more air inlet holes. This airflow (or the associated change in pressure) is detected by a sensor, e.g. a pressure sensor, which in turn activates the heater 36 to vaporize the nicotine liquid fed from the reservoir 38. The airflow passes from the control unit into the vaporizer, where the airflow combines with the nicotine vapor. This combination of airflow and nicotine vapor (in effect, an aerosol) then passes through the cartomizer 30 and out of the mouthpiece 35 to be inhaled by a user. The cartomizer 30 may be detached from the control unit and disposed of when the supply of nicotine liquid is exhausted (and then replaced with another cartomizer).

It will be appreciated that the e-cigarette 10 shown in FIG. 1 is presented by way of example only, and many other implementations may be adopted. For example, in some implementations, the cartomizer 30 is split into a cartridge containing the liquid reservoir 38 and a separate vaporizer portion containing the heater 36. In this configuration, the cartridge may be disposed of after the liquid in reservoir 38 has been exhausted, but the separate vaporizer portion containing the heater 36 is retained. Alternatively, an e-cigarette may be provided with a cartomizer 30 as shown in FIG. 1, or else constructed as a one-piece (unitary) device, but the liquid reservoir 38 is in the form of a (user-)replaceable cartridge. Further possible variations are that the heater 36 may be located at the opposite end of the cartomizer 30 from that shown in FIG. 1, i.e. between the liquid reservoir 38 and the mouthpiece 35, or else the heater 36 is located along a central axis LA of the cartomizer, and the liquid reservoir is in the form of an annular structure which is radially outside the heater 35.

The skilled person will also be aware of a number of possible variations for the control unit 20. For example, airflow may enter the control unit at the tip end, i.e. the opposite end to connector 21A, in addition to or instead of the airflow adjacent to PCB 28. In this case the airflow would typically be drawn towards the cartomizer along a passage between the battery 54 and the outer wall of the control unit. Similarly, the control unit may comprise a PCB located on or near the tip end, e.g. between the battery and the tip end. Such a PCB may be provided in addition to or instead of PCB 28.

Furthermore, an e-cigarette may support charging at the tip end, or via a socket elsewhere on the device, in addition to or in place of charging at the connection point between the cartomizer and the control unit. (It will be appreciated that some e-cigarettes are provided as essentially integrated units, in which case a user is unable to disconnect the cartomizer from the control unit). Other e-cigarettes may also support wireless (induction) charging, in addition to (or instead of) wired charging.

The above discussion of potential variations to the e-cigarette shown in FIG. 1 is by way of example. The skilled person will aware of further potential variations (and combination of variations) for the e-cigarette 10.

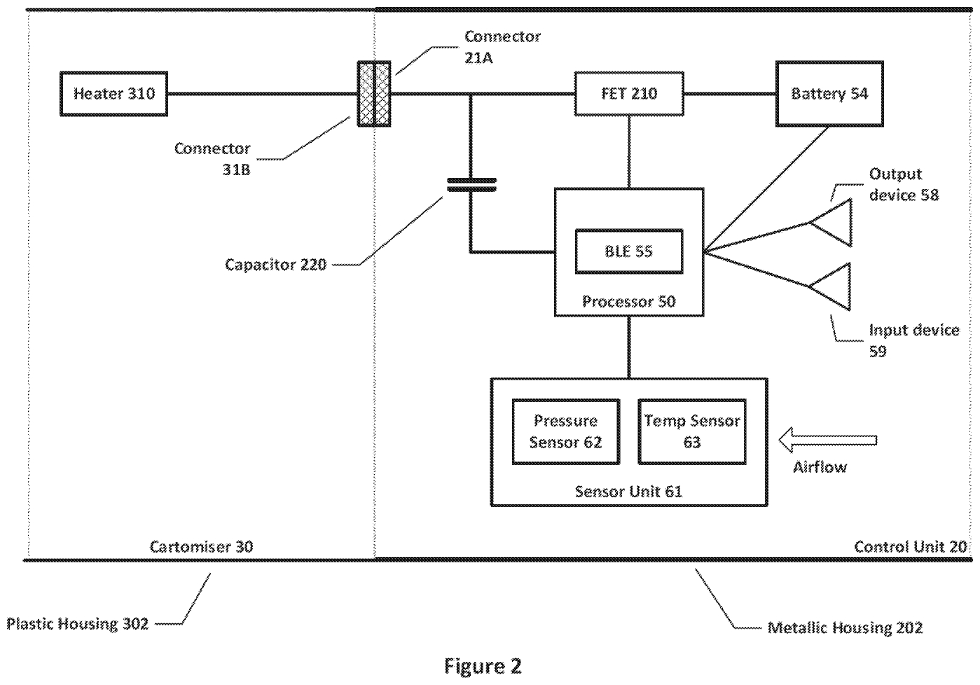

FIG. 2 is a schematic diagram of the main functional components of the e-cigarette 10 of FIG. 1 in accordance with some embodiments of the disclosure. N.B. FIG. 2 is primarily concerned with electrical connectivity and functionality—it is not intended to indicate the physical sizing of the different components, nor details of their physical placement within the control unit 20 or cartomizer 30. In addition, it will be appreciated that at least some of the components shown in FIG. 2 located within the control unit 20 may be mounted on the circuit board 28. Alternatively, one or more of such components may instead be accommodated in the control unit to operate in conjunction with the circuit board 28, but not physically mounted on the circuit board itself. For example, these components may be located on one or more additional circuit boards, or they may be separately located (such as battery 54).

As shown in FIG. 2, the cartomizer contains heater 310 which receives power through connector 31B. The control unit 20 includes an electrical socket or connector 21A for connecting to the corresponding connector 31B of the cartomizer 30 (or potentially to a USB charging device). This then provides electrical connectivity between the control unit 20 and the cartomizer 30.

The control unit 20 further includes a sensor unit 61, which is located in or adjacent to the air path through the control unit 20 from the air inlet(s) to the air outlet (to the cartomizer 30 through the connector 21A). The sensor unit contains a pressure sensor 62 and temperature sensor 63 (also in or adjacent to this air path). The control unit further includes a capacitor 220, a processor 50, a field effect transistor (FET) switch 210, a battery 54, and input and output devices 59, 58.

The operations of the processor 50 and other electronic components, such as the pressure sensor 62, are generally controlled at least in part by software programs running on the processor (or other components). Such software programs may be stored in non-volatile memory, such as ROM, which can be integrated into the processor 50 itself, or provided as a separate component. The processor 50 may access the ROM to load and execute individual software programs as and when required. The processor 50 also contains appropriate communications facilities, e.g. pins or pads (plus corresponding control software), for communicating as appropriate with other devices in the control unit 20, such as the pressure sensor 62.

The output device(s) 58 may provide visible, audio and/or haptic output. For example, the output device(s) may include a speaker 58, a vibrator, and/or one or more lights. The lights are typically provided in the form of one or more light emitting diodes (LEDs), which may be the same or different colors (or multi-colored). In the case of multi-colored). LEDs, different colors are obtained by switching different colored, e.g. red, green or blue, LEDs on, optionally at different relative brightnesses to give corresponding relative variations in color. Where red, green and blue LEDs are provided together, a full range of colors is possible, whilst if only two out of the three red, green and blue LEDs are provided, only a respective sub-range of colors can be obtained.

The output from the output device may be used to signal to the user various conditions or states within the e-cigarette, such as a low battery warning. Different output signals may be used for signaling different states or conditions. For example, if the output device 58 is an audio speaker, different states or conditions may be represented by tones or beeps of different pitch and/or duration, and/or by providing multiple such beeps or tones. Alternatively, if the output device 58 includes one or more lights, different states or conditions may be represented by using different colors, pulses of light or continuous illumination, different pulse durations, and so on. For example, one indicator light might be utilized to show a low battery warning, while another indicator light might be used to indicate that the liquid reservoir 38 is nearly depleted. It will be appreciated that a given e-cigarette may include output devices to support multiple different output modes (audio, visual) etc.

The input device(s) 59 may be provided in various forms. For example, an input device (or devices) may be implemented as buttons on the outside of the e-cigarette—e.g. as mechanical, electrical or capacitive (touch) sensors. Some devices may support blowing into the e-cigarette as an input mechanism (such blowing may be detected by pressure sensor 62, which would then be also acting as a form of input device 59), and/or connecting/disconnecting the cartomizer 30 and control unit 20 as another form of input mechanism. Again, it will be appreciated that a given e-cigarette may include input devices 59 to support multiple different input modes.

As noted above, the e-cigarette 10 provides an air path from the air inlet through the e-cigarette, past the pressure sensor 62 and the heater 310 in the cartomizer 30 to the mouthpiece 35. Thus when a user inhales on the mouthpiece of the e-cigarette, the processor 50 detects such inhalation based on information from the pressure sensor 62. In response to such a detection, the CPU supplies power from the battery 54 to the heater, which thereby heats and vaporizes the nicotine from the liquid reservoir 38 for inhalation by the user.

In the particular implementation shown in FIG. 2, a FET 210 is connected between the battery 54 and the connector 21A. This FET 210 acts as a switch. The processor 50 is connected to the gate of the FET to operate the switch, thereby allowing the processor to switch on and off the flow of power from the battery 54 to heater 310 according to the status of the detected airflow. It will be appreciated that the heater current can be relatively large, for example, in the range 1-5 amps, and hence the FET 210 should be implemented to support such current control (likewise for any other form of switch that might be used in place of FET 210).

In order to provide more fine-grained control of the amount of power flowing from the battery 54 to the heater 310, a pulse-width modulation (PWM) scheme may be adopted. A PWM scheme may be based on a repetition period of say 1 ms. Within each such period, the switch 210 is turned on for a proportion of the period, and turned off for the remaining proportion of the period. This is parameterized by a duty cycle, whereby a duty cycle of 0 indicates that the switch is off for all of each period (i.e. in effect, permanently off), a duty cycle of 0.33 indicates that the switch is on for a third of each period, a duty cycle of 0.66 indicates that the switch is on for two-thirds of each period, and a duty cycle of 1 indicates that the FET is on for all of each period (i.e. in effect, permanently on). It will be appreciated that these are only given as example settings for the duty cycle, and intermediate values can be used as appropriate.

The use of PWM provides an effective power to the heater which is given by the nominal available power (based on the battery output voltage and the heater resistance) multiplied by the duty cycle. The processor 50 may, for example, utilize a duty cycle of 1 (i.e. full power) at the start of an inhalation to initially raise the heater 310 to its desired operating temperature as quickly as possible. Once this desired operating temperature has been achieved, the processor 50 may then reduce the duty cycle to some suitable value in order to supply the heater 310 with the desired operating power

As shown in FIG. 2, the processor 50 includes a communications interface 55 for wireless communications, in particular, support for Bluetooth® Low Energy (BLE) communications.

Optionally the heater 310 may be utilized as an antenna for use by the communications interface 55 for transmitting and receiving the wireless communications. One motivation for this is that the control unit 20 may have a metal housing 202, whereas the cartomizer portion 30 may have a plastic housing 302 (reflecting the fact that the cartomizer 30 is disposable, whereas the control unit 20 is retained and therefore may benefit from being more durable). The metal housing acts as a screen or barrier which can affect the operation of an antenna located within the control unit 20 itself. However, utilizing the heater 310 as the antenna for the wireless communications can help to avoid this metal screening because of the plastic housing of the cartomizer, but without adding additional components or complexity (or cost) to the cartomizer. Alternatively a separate antenna may be provided (not shown), or a portion of the metal housing may be used.

If the heater is used as an antenna then as shown in FIG. 2, the processor 50, more particularly the communications interface 55, may be coupled to the power line from the battery 54 to the heater 310 (via connector 31B) by a capacitor 220. This capacitive coupling occurs downstream of the switch 210, since the wireless communications may operate when the heater is not powered for heating (as discussed in more detail below). It will be appreciated that capacitor 220 helps prevent the power supply from the battery 54 to the heater 310 being diverted back to the processor 50.

Note that the capacitive coupling may be implemented using a more complex LC (inductor-capacitor) network, which can also provide impedance matching with the output of the communications interface 55. (As known to the person skilled in the art, this impedance matching can help support proper transfer of signals between the communications interface 55 and the heater 310 acting as the antenna, rather than having such signals reflected back along the connection).

In some implementations, the processor 50 and communications interface are implemented using a Dialog DA14580 chip from Dialog Semiconductor PLC, based in Reading, United Kingdom. Further information (and a data sheet) for this chip is available at: http://www.dialog-semiconductor.com/products/bluetooth-smart/smartbond-da14580.

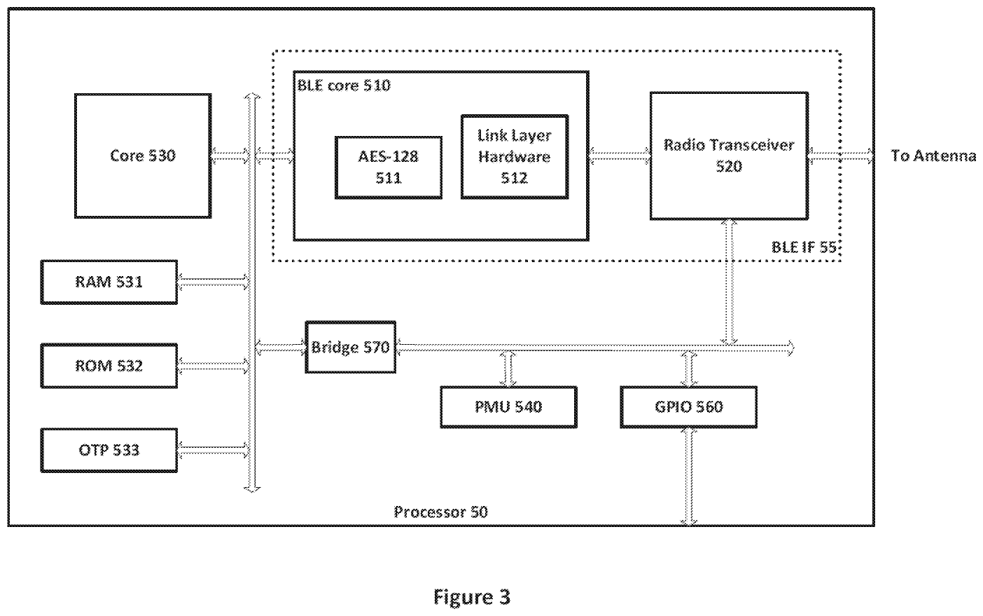

FIG. 3 presents a high-level and simplified overview of this chip 50, including the communications interface 55 for supporting Bluetooth® Low Energy. This interface includes in particular a radio transceiver 520 for performing signal modulation and demodulation, etc., link layer hardware 512, and an advanced encryption facility (128 bits) 511. The output from the radio transceiver 520 is connected to the antenna (for example, to the heater 310 acting as the antenna via capacitive coupling 220 and connectors 21A and 31B).

The remainder of processor 50 includes a general processing core 530, RAM 531, ROM 532, a one-time programming (OTP) unit 533, a general purpose I/O system 560 (for communicating with other components on the PCB 28), a power management unit 540 and a bridge 570 for connecting two buses. Software instructions stored in the ROM 532 and/or OTP unit 533 may be loaded into RAM 531 (and/or into memory provided as part of core 530) for execution by one or more processing units within core 530. These software instructions cause the processor 50 to implement various functionality described herein, such as interfacing with the sensor unit 61 and controlling the heater accordingly. Note that although the device shown in FIG. 3 acts as both a communications interface 55 and also as a general controller for the electronic vapor provision system 10, in other embodiments these two functions may be split between two or more different devices (chips)—e.g. one chip may serve as the communications interface 55, and another chip as the general controller for the electronic vapor provision system 10.

In some implementations, the processor 50 may be configured to prevent wireless communications when the heater is being used for vaporizing liquid from reservoir 38. For example, wireless communications may be suspended, terminated or prevented from starting when switch 210 is switched on. Conversely, if wireless communications are ongoing, then activation of the heater may be prevented—e.g. by disregarding a detection of airflow from the sensor unit 61, and/or by not operating switch 210 to turn on power to the heater 310 while the wireless communications are progressing.

One reason for preventing the simultaneous operation of heater 310 for both heating and wireless communications in some implementations is to help avoid potential interference from the PWM control of the heater. This PWM control has its own frequency (based on the repetition frequency of the pulses), albeit typically much lower than the frequency used for the wireless communications, and the two could potentially interfere with one another. In some situations, such interference may not, in practice, cause any problems, and simultaneous operation of heater 310 for both heating and wireless communications may be allowed (if so desired). This may be facilitated, for example, by techniques such as the appropriate selection of signal strengths and/or PWM frequency, the provision of suitable filtering, etc.

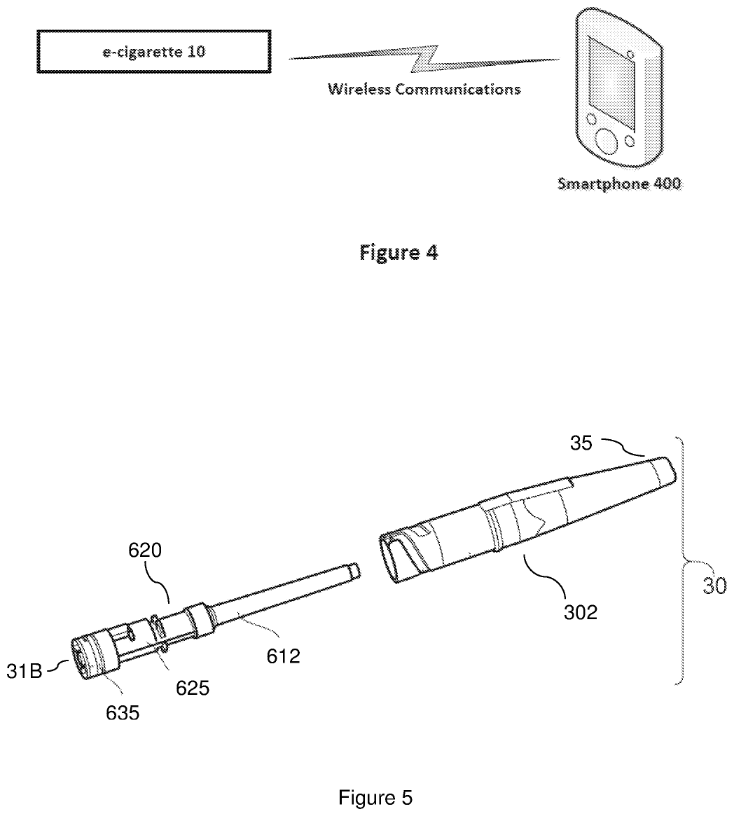

FIG. 4 is a schematic diagram showing Bluetooth® Low Energy communications between an e-cigarette 10 and an application (app) running on a smartphone 400 or other suitable mobile communication device (tablet, laptop, smartwatch, etc.). Such communications can be used for a wide range of purposes, for example, to upgrade firmware on the e-cigarette 10, to retrieve usage and/or diagnostic data from the e-cigarette 10, to reset or unlock the e-cigarette 10, to control settings on the e-cigarette, etc.

In general terms, when the e-cigarette 10 is switched on, such as by using input device 59, or possibly by joining the cartomizer 30 to the control unit 20, it starts to advertise for Bluetooth® Low Energy communication. If this outgoing communication is received by smartphone 400, then the smartphone 400 requests a connection to the e-cigarette 10. The e-cigarette may notify this request to a user via output device 58, and wait for the user to accept or reject the request via input device 59. Assuming the request is accepted, the e-cigarette 10 is able to communicate further with the smartphone 400. Note that the e-cigarette may remember the identity of smartphone 400 and be able to accept future connection requests automatically from that smartphone. Once the connection has been established, the smartphone 400 and the e-cigarette 10 operate in a client-server mode, with the smartphone operating as a client that initiates and sends requests to the e-cigarette which therefore operates as a server (and responds to the requests as appropriate).

A Bluetooth® Low Energy link (also known as Bluetooth Smart®) implements the IEEE 802.15.1 standard, and operates at a frequency of 2.4-2.5 GHz, corresponding to a wavelength of about 12 cm, with data rates of up to 1 Mbit/s. The set-up time for a connection is less than 6 ms, and the average power consumption can be very low—of the order 1 mW or less. A Bluetooth Low Energy link may extend up to some 50 m. However, for the situation shown in FIG. 4, the e-cigarette 10 and the smartphone 400 will typically belong to the same person, and will therefore be in much closer proximity to one another—e.g. 1 m. Further information about Bluetooth Low Energy can be found at www.bluetooth.com.

It will be appreciated that e-cigarette 10 may support other communications protocols for communication with smartphone 400 (or any other appropriate device). Such other communications protocols may be instead of, or in addition to, Bluetooth Low Energy. Examples of such other communications protocols include Bluetooth® (not the low energy variant), see for example, www.bluetooth.com, near field communications (NFC), as per ISO 13157, and WiFi NFC communications operate at much lower wavelengths than Bluetooth (13.56 MHz) and generally have a much shorter range—say <0.2 m. However, this short range is still compatible with most usage scenarios such as shown in FIG. 4. Meanwhile, low-power WiFi® communications, such as IEEE802.11ah, IEEE802.11v, or similar, may be employed between the e-cigarette 10 and a remote device. In each case, a suitable communications chipset may be included on PCB 28, either as part of the processor 50 or as a separate component. The skilled person will be aware of other wireless communication protocols that may be employed in e-cigarette 10.

FIG. 5 is a schematic, exploded view of an example cartomizer 30 in accordance with some embodiments. The cartomizer has an outer plastic housing 302, a mouthpiece 35 (which may be formed as part of the housing), a vaporizer 620, a hollow inner tube 612, and a connector 31B for attaching to a control unit. An airflow path through the cartomizer 30 starts with an air inlet through connector 31B, then through the interior of vaporizer 625 and hollow tube 612, and finally out through the mouthpiece 35. The cartomizer 30 retains liquid in an annular region between (i) the plastic housing 302, and (ii) the vaporizer 620 and the inner tube 612. The connector 31B is provided with a seal 635 to help maintain liquid in this region and to prevent leakage.

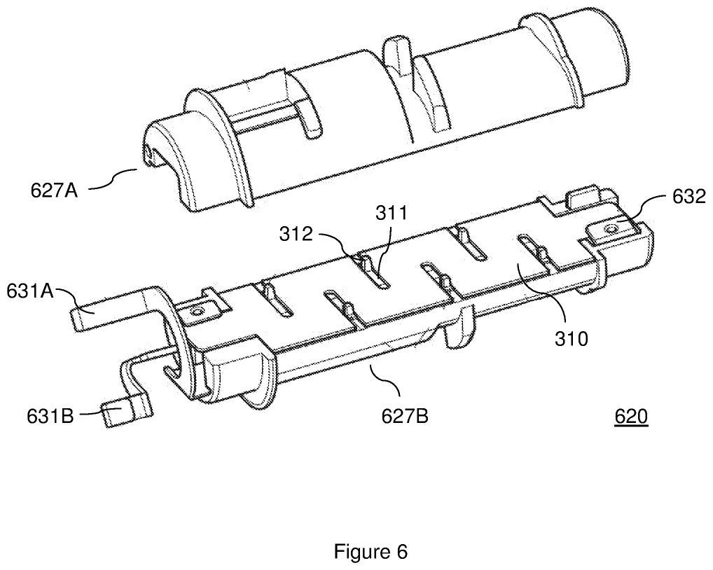

FIG. 6 is a schematic, exploded view of the vaporizer 620 from the example cartomizer 30 shown in FIG. 5. The vaporizer 620 has a substantially cylindrical housing (cradle) formed from two components, 627A, 627B, each having a substantially semi-circular cross-section. When assembled, the edges of the components 627A, 627B do not completely abut one another (at least, not along their entire length), but rather a slight gap 625 remains (as indicated in FIG. 5). This gap allows liquid from the outer reservoir around the vaporizer and tube 612 to enter into the interior of the vaporizer 620.

One of the components 627B of the vaporizer is shown in FIG. 6 supporting a heater 310. There are two connectors 631A, 631B shown for supplying power (and a wireless communication signal) to the heater 310. More particular, these connectors 631A, 631B link the heater to connector 31B, and from there to the control unit 20. (Note that connector 631A is joined to pad 632A at the far end of vaporizer 620 from connector 31B by an electrical connection that passes under the heater 310 and which is not visible in FIG. 6).

The heater 310 comprises a heating element formed from a sintered metal fiber material and is generally in the form of a sheet or porous, conducting material (such as steel). However, it will be appreciated that other porous conducting materials may be used. The overall resistance of the heating element in the example of FIG. 6 is around 1 ohm. However, it will be appreciated that other resistances may be selected, for example having regard to the available battery voltage and the desired temperature/power dissipation characteristics of the heating element. In this regard, the relevant characteristics may be selected in accordance with the desired aerosol (vapor) generation properties for the device depending on the source liquid of interest.

The main portion of the heating element is generally rectangular with a length (i.e. in a direction running between the connector 31B and the contact 632A) of around 20 mm and a width of around 8 mm. The thickness of the sheet comprising the heating element in this example is around 0.15 mm.

As can be seen in FIG. 6, the generally-rectangular main portion of the heating element has slots 311 extending inwardly from each of the longer sides. These slots 311 engage pegs 312 provided by vaporizer housing component 627B, thereby helping to maintain the position of the heating element in relation to the housing components 627A, 627B.

The slots extend inwardly by around 4.8 mm and have a width of around 0.6 mm. The slots 311 extending inwardly are separated from one another by around 5.4 mm on each side of the heating element, with the slots extending inwardly from the opposing sides being offset from one another by around half this spacing. A consequence of this arrangement of slots is that current flow along the heating element is in effect forced to follow a meandering path, which results in a concentration of current and electrical power around the ends of the slots. The different current/power densities at different locations on the heating element mean there are areas of relatively high current density that become hotter than areas of relatively low current density. This in effect provides the heating element with a range of different temperatures and temperature gradients, which can be desirable in the context of aerosol provision systems. This is because different components of a source liquid may aerosolize/vaporize at different temperatures, and so providing a heating element with a range of temperatures can help simultaneously aerosolize a range of different components in the source liquid.

The heater 310 shown in FIG. 6, having a substantially planar shape which is elongated in one direction, is well-suited to act as an antenna. In conjunction with the metal housing 202 of the control unit, the heater 310 forms an approximate dipole configuration, which typically has a physical size of the same order of magnitude as the wavelength of Bluetooth Low Energy communications—i.e. a size of several centimeters (allowing for both the heater 310 and the metal housing 202) against a wavelength of around 12 cm.

Although FIG. 6 illustrates one shape and configuration of the heater 310 (heating element), the skilled person will be aware of various other possibilities. For example, the heater may be provided as a coil or some other configuration of resistive wire. Another possibility is that the heater is configured as a pipe containing liquid to be vaporized (such as some form of tobacco product). In this case, the pipe may be used primarily to transport heat from a place of generation (e.g. by a coil or other heating element) to the liquid to be vaporized. In such a case, the pipe still acts as a heater in respect of the liquid to be heated. Such configurations can again optionally be used as an antenna to support wireless configurations.

As was noted previously herein, a suitable e-cigarette 10 can communicate with a mobile communication device 400, for example by paring the devices using the Bluetooth® low energy protocol.

Consequently, it is possible to provide additional functionality to the e-cigarette and/or to a system comprising the e-cigarette and the smart phone, by providing suitable software instructions (for example in the form of an app) to run on the smart phone.

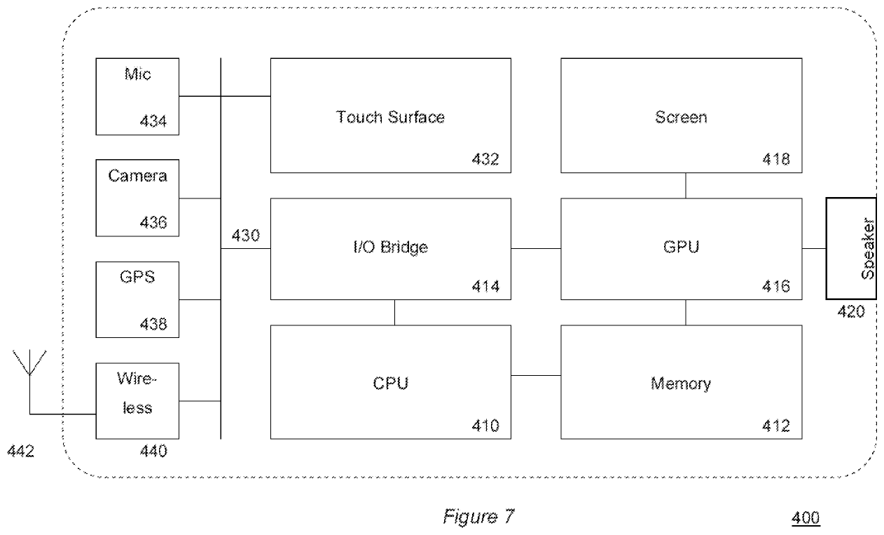

Turning now to FIG. 7, a typical smartphone 400 comprises a central processing unit (CPU) (410). The CPU may communicate with components of the smart phone either through direct connections or via an I/O bridge 414 and/or a bus 430 as applicable.

In the example shown in FIG. 7, the CPU communicates directly with a memory 412, which may comprise a persistent memory such as for example Flash® memory for storing an operating system and applications (apps), and volatile memory such as RAM for holding data currently in use by the CPU. Typically persistent and volatile memories are formed by physically distinct units (not shown). In addition, the memory may separately comprise plug-in memory such as a microSD card, and also subscriber information data on a subscriber information module (SIM) (not shown).

The smart phone may also comprise a graphics processing unit (GPU) 416. The GPU may communicate directly with the CPU or via the I/O bridge, or may be part of the CPU. The GPU may share RAM with the CPU or may have its own dedicated RAM (not shown) and is connected to the display 418 of the mobile phone. The display is typically a liquid crystal (LCD) or organic light-emitting diode (OLED) display, but may be any suitable display technology, such as e-ink. Optionally the GPU may also be used to drive one or more loudspeakers 420 of the smart phone.

Alternatively, the speaker may be connected to the CPU via the I/O bridge and the bus. Other components of the smart phone may be similarly connected via the bus, including a touch surface 432 such as a capacitive touch surface overlaid on the screen for the purposes of providing a touch input to the device, a microphone 434 for receiving speech from the user, one or more cameras 436 for capturing images, a global positioning system (GPS) unit 438 for obtaining an estimate of the smart phones geographical position, and wireless communication means 440.

The wireless communication means 440 may in turn comprise several separate wireless communication systems adhering to different standards and/or protocols, such as Bluetooth® (standard or low-energy variants), near field communication and Wi-Fi® as described previously, and also phone based communication such as 2G, 3G and/or 4G.

The systems are typically powered by a battery (not shown) that may be chargeable via a power input (not shown) that in turn may be part of a data link such as USB (not shown).

It will be appreciated that different smartphones may include different features (for example a compass or a buzzer) and may omit some of those listed above (for example a touch surface).

Thus more generally, in an embodiment of the present disclosure a suitable remote device such as smart phone 400 will comprise a CPU and a memory for storing and running an app, and wireless communication means operable to instigate and maintain wireless communication with the e-cigarette 10. It will be appreciated however that the remote device may be a device that has these capabilities, such as a tablet, laptop, smart TV or the like.

In an embodiment of the present disclosure, a diagnostic system for an electronic vapor provision system (EVPS) comprises a detection processor (50, 410) adapted (for example by suitable software instruction) to detect one or more of a plurality of predetermined misuse events. The diagnostic system also comprises a diagnostic processor (50, 410) adapted (for example by suitable software instruction) to perform, in response to detection of a predetermined misuse event, at least one corresponding system diagnostic; and similarly the diagnostic system comprises an output processor (50, 410, 416) adapted to indicate the result of the or each performed diagnostic to a user.

The detection processor receives a signal from one or more sensors (not shown) incorporated within the EVPS, for example within sensor unit 61, but optionally elsewhere as applicable. The sensors may include one or more of an accelerometer, an electronic thermometer, an input voltage sensor, an input current sensor, a payload closure sensor, and a moisture sensor.

In an embodiment of the present disclosure, the EVPS comprises an accelerometer sensor for detection of misuse. The sensor is operable to output a signal indicative of acceleration (or a signal from which acceleration can be derived). A threshold absolute acceleration value is then set, for example based upon testing of the EVPS to determine what level of acceleration may cause damage to the EVPS. Such acceleration is typically caused by dropping the EVPS onto a hard surface, causing rapid deceleration (i.e. negative acceleration).

Optionally, acceleration on more than one axis may be detected, for example by use of a multi-axis accelerometer. For example, an EVPS may be more liable to damage if it lands on one end than if it lands flat along its length (or vice versa). Hence different respective thresholds for different respective axes of acceleration may be used.

The detection processor may then compare the signal from the accelerometer (typically after analogue to digital conversion) with the or each threshold to detect whether a signal exceeds a threshold value, and if so this result is passed to the diagnostic processor to indicate a specific form of misuse, namely dropping the EVPS.

In response to the specific form of misuse, the diagnostic processor performs a corresponding system diagnostic. System diagnostics may include one or more of a circuit integrity test, a cell (battery) integrity test, and a moisture test. Other tests may also be envisaged, such as testing the integrity of a seal on a component of the EVPS.

In an embodiment of the present disclosure, in the case of an accelerometer signal exceeding a threshold indicative of misuse by dropping of the EVPS, the diagnostic processor performs the corresponding system diagnostic of a circuit integrity test.

The circuit integrity test will typically comprise systematically testing each circuit controllable and/or measurable by the diagnostic processor (or equally a processor of the EVPS receiving instruction from the diagnostic processor, either on a per-circuit basis or to conduct a predefined circuit test).

The or each circuit integrity test, as applicable, may test that a circuit closes and/or opens as instructed, and/or that one or more of a voltage, current and resistance within a circuit is within a predetermined operational range. Furthermore, tests of multiple circuits may be implemented in parallel to simulate power loads in normal use.

To the extent that voltage, current or resistance in a circuit may in turn depend upon the output of the battery/cell 54 of the EVPS, an initial cell integrity test may also be performed, or partially performed. This may comprise measuring the voltage and/or current from the cell on a predetermined circuit (either a dedicated test circuit, or a circuit that is likely to be robust, such as one supplying the processor, or an LED), to check that these are within a predetermined operation range, and, for circuit integrity tests, to provide baseline values. The cell integrity test may also include checking any sensor used to detect proper seating (placement) of the cell, and/or that the cell is within an operational temperature range.

Optionally, a moisture test may be conducted, to detect the presence of a leak, for example due to a payload reservoir breaking or becoming loose. One or more moisture detection sensors may be incorporated into the EVPS, for example near the point of attachment of a reservoir to the EVPS, and/or near any components that may be damaged by liquid, such as the processor or the power cell. If moisture is detected, a corresponding signal is received by the detection processor.

In the case that the diagnostic processor is remote to the EVPS, initial tests may be that wireless communications are operable, and that any processor carrying out functions of the diagnostic process within the EVPS is operable.

In an embodiment of the present disclosure, the EVPS comprises at least a first electronic thermometer sensor for detection of misuse. The thermometer is operable to output a signal proportional to temperature. One thermometer may be the thermometer 63 used for measuring heater/vapor temperatures, but may be separate.

A threshold absolute temperature value is then set, for example based upon testing of the EVPS to determine what level of temperature may cause damage to the EVPS. It will be appreciated that certain elements of the EVPS are intended to become hot during normal use, in order to generate a vapor. However, the or each thermometer may be placed at a location where a different operational temperature range is expected, such as in proximity to the power cell and/or a processor of the EVPS. Different thresholds (or equivalently range limits) may be established for different thermometers/zones of the EVPS.

The detection processor may then compare the signal from the or each thermometer (typically after analogue to digital conversion) with the or each threshold to detect whether a signal exceeds a threshold value, and if so this result is passed to the diagnostic processor to indicate a specific form of misuse, namely allowing the EVPS to become overly hot. This may occur for example if the device is left in the sun in a car, or placed near a heat source such as a kitchen hob.

It will be appreciated that a suitably placed temperature sensor may similarly detect if a replacement battery or other user-modification of an EVPS is causing operational temperatures of any aspect of the EVPS to fall outside of a predetermined range, and thereby constitutes misuse by adapting the device to function outside its recommended operational range. This may include detecting the temperature of the power cell, or of any processor of the EVPS, or of the heater itself or of the resulting vapor.

It will also be appreciated that equally the temperature may become too cold, which in turn may adversely affect operation of the power cell whilst simultaneously requiring more power to raise the heater to a vaporization temperature.

In an embodiment of the present disclosure, in the case of a thermometer signal exceeding a threshold (or equally falling outside a predetermined range) indicative of misuse by modding or over heating the EVPS, the diagnostic processor performs the corresponding system diagnostic of a cell integrity test.

As noted above, this test may comprise a voltage and/or current test, and (separate to the misuse temperature test), a cell temperature test. It will be appreciated that in this case, the same electronic thermometer may be used initially to detect potential misuse, and secondly to detect any potential issue with the power cell. In this case, there may be different respective thresholds or ranges associated with potential misuse and with battery malfunction.

In an embodiment of the present disclosure, the EVPS comprises at least one of an input voltage sensor and input current sensor for detection of misuse. The voltage and current sensors are operable to output a signal proportional to voltage and current, respectively.

A threshold absolute voltage and/or current value is then set, for example based upon testing of what level of voltage and/or current may cause damage to the EVPS during charging (or optionally discharging) of the cell, or based upon a manufacturer's rating of the cell or of an approved charging unit.

Such damage may occur when a non-standard charger is used, or when a non-standard power cell is used, or both.

As noted above, the voltage and/or current sensors may be used during charging. Optionally they may also be used during discharge, for example during a cell integrity test or a circuit integrity test, and hence have a dual role. Alternatively, separate voltage and/or current sensors may be used for charging and discharging tests. Different threshold values for charging and discharging may be used, and these values may be co-dependent, such a threshold or range for the current is set for a given voltage, and/or vice-versa.

The detection processor may then compare the signal from the voltage and/or current sensor (typically after analogue to digital conversion) with the or each threshold to detect whether a signal exceeds a threshold value, and if so this result is passed to the diagnostic processor to indicate a specific form of misuse, namely use of an unauthorized power supply and/or battery.

In an embodiment of the present disclosure, in the case of a voltage and/or current signal exceeding a threshold indicative of such misuse, the diagnostic processor performs the corresponding system diagnostic of a cell integrity test as described previously herein.

As noted previously herein, the cell integrity test may comprise cell seating/position detection, for example by use of a suitably positioned button or electrical contact. Similarly, the cell integrity test may comprise detection of the authenticity of the cell, for example by used of a secure handshake with an ID chip within the cell. This may be done by the EVPS, or (via wireless communications) with a mobile communication device running a suitable app. Optionally, the cell may comprise an RFID or NFC chip enabling direct wireless communication with a suitable mobile communication device running a suitable app. This would enable authentication by placing the mobile communication device on the EVPS. It could also enable authentication of replacement batteries before they are inserted into the EVPS, for example at the point of sale, or when being borrowed or exchanged between devices.

In an embodiment of the present disclosure, the EVPS comprises a payload closure sensor for detection of misuse. The closure sensor is operable to output a signal indicative that the payload is suitably mounted within the EVPS, typically by detecting the physical presence of part of the payload container at a predetermined position, and/or optionally by indicating the integrity of a seal between the payload container and the EVPS.

The sensor is typically one or more electrical contacts and/or circuit(s) that are closed by the proper interaction of the payload container and the EVPS. The position of such contacts is selected according to the design of the EVPS and payload container. Typically the payload container may have either an asymmetric feature forcing a specific positioning, or a connection mechanism (such as a screw thread) that has a specific terminal position (i.e. when fully screwed in). Hence a contact may be positioned at the asymmetry feature or at the terminal end of a screw thread. Other strategies will be apparent to the skilled person.

For a seal, the resistivity, capacitance or other electrical property of the seal is likely to change if it is broken or wears thin. Hence if this property falls outside a predetermined range, the seal integrity may be assumed to be compromised.

The detection processor may then detect the presence or absence of a payload closure sensor signal, and/or compare the signal from a seal integrity electrical sensor (typically after analogue to digital conversion) with a predetermined operation range to detect if the signal is outside the range, and if so or if a payload closure sensor signal is absent, this result is passed to the diagnostic processor to indicate a specific form of misuse, namely improper installation of a payload container.

In an embodiment of the present disclosure, in the case of a payload closure sensor signal or seal integrity signal being indicative of such misuse, in the case of a liquid payload then the diagnostic processor performs one or more corresponding system diagnostics, including a moisture test, a circuit integrity test, and a cell integrity test, as respectively described previously. This is because liquid within the EVPS may damage multiple aspects of the device, as described previously.

In an embodiment of the present disclosure, the EVPS comprises one or more moisture sensors for detection of misuse. The moisture sensor is operable to output a signal indicative moisture is present local to it within the EVPS. It will be appreciated that certain parts of the EVPS will contain moisture (vapor and possibly condensates) during normal use. However, other parts of the EVPS are expected to remain dry. Unwanted moisture (i.e. in a part of the EVPS that should not contain moisture) may be found within the EVPS if a liquid payload has been improperly fitted, as described above, but may also occur for example because the EVPS has been dropped in water, or if the integrity of the shell of the EVPS (or of an internal compartment) has been compromised, for example in a humid climate.

The detection processor may then detect the presence or absence of one or more moisture sensor signals, to detect if unwanted moisture is found within the EVPS, and if so then this result is passed to the diagnostic processor to indicate a specific form of misuse, namely wetting of the EVPS (though misuse of a reservoir, dropping the EVPS in water, and the like).

In an embodiment of the present disclosure, in the case of a moisture sensor signal being indicative of such misuse, the diagnostic processor performs one or more corresponding system diagnostics, including a circuit integrity test and a cell integrity test, as respectively described previously. This is because liquid within the EVPS may damage multiple aspects of the device, as described previously.

It will be appreciated that the EVPS may comprise one or more of the above sensors.

Correspondingly, the diagnostic system may perform a corresponding one or more of the above detections and in response to a detection being indicative of a specific misuse, performing at least one corresponding system diagnostic.

In response to any of the above diagnostics indicating a fault with the EVPS (for example, if the cell integrity test or circuit integrity test fails, or the temperature of a component of the EVPS is above a predetermined threshold, or if a predetermined component is detected to be proximate to moisture), then an output processor is adapted to indicate the result of the or each performed diagnostic to a user.

The EVPS may have a form factor that enables the use of the display that can provide alphanumeric information to the user, or a simpler user interface may be implemented, such as an LED that may activate in the event of a fault, or change color in the event of a fault.

Alternatively or in addition, the result of diagnostic indicating a fault may be transmitted to a remote mobile communication device, which provides the information to the user via a user interface, such as within an app.

More generally, whilst the diagnostic system may be wholly contained within an EPS, optionally components of the diagnostic system may be shared between the EVPS and a remote mobile communication device (such as a smart phone).

Hence, in an embodiment of the present disclosure, as noted above the EVPS comprises a wireless communications circuit for communication with a remote mobile communication device, and the remote mobile communication device comprises at least the detection processor. Subsequently, signals from one or more sensors of the EVPS are transmitted to the remote mobile communication device.

The mobile communication device can perform the detection, and typically will also perform the diagnostic and output processes, with a CPU of the mobile communication device operating as the detection processor, and optionally diagnostic and output processors, under suitable software instruction.

Meanwhile, in an embodiment of the present disclosure, the EVPS comprises the detection processor, rather than the mobile communication device.

As before, the EVPS comprises a wireless communications circuit for communication with a remote mobile communication device, and the remote mobile communication device comprises at least the diagnostic processor.

This time, a respective detection by the detection processor in the EVP is transmitted to the remote mobile communication device.

The mobile communication device can then perform the diagnosis, and typically will also perform the output process, with a CPU of the mobile communication device operating as the diagnostic processor and optionally output processors, under suitable software instruction.

Similarly, and as described previously, in another embodiment of the present disclosure the EVPS comprises the diagnostic processor, and the aforementioned a wireless communications circuit for communication with a remote mobile communication device, with the remote mobile communication device comprising the output processor.

Then as previously described, a result of the or each performed diagnostic is transmitted to the remote mobile communication device.

Then as described previously, mobile communication device can provide the information to the user via a user interface, such as within an app.

To facilitate sharing of some or all of the detection, diagnosis and output between the EVPS and the mobile communication device, responsive to one or more sensors in the EVPS, the mobile communication device requires suitable and corresponding adaptation.

Hence, in an embodiment of the present disclosure, a mobile communication device 400 comprises a wireless communications circuit 440 for communication with a remote EVPS 10, a display 418; an output processor (for example CPU 410 operating under suitable software instruction), operable to output to the display a result of at least a first diagnostic test performed for the EVPS in response to detection of a corresponding predetermined misuse event, based on data received from the EVPS.

In this case, the data received from the EPVS is likely to be diagnostic output data, optionally together with relevant values from one or more sensors.

Meanwhile, in an embodiment of the present disclosure, the mobile communication device additionally comprises a diagnostic processor (for example CPU 410 operating under suitable software instruction), operable to perform at least a first diagnostic test for the EVPS in response to detection of a corresponding predetermined misuse event, based on data received from the EVPS.

In this case, the data received from the EVPS is likely to be detection data indicating a specific misuse, optionally together with relevant values from one or more sensors.

Further, in an embodiment of the present disclosure, the mobile communication device additionally comprises a detection processor (for example CPU 410 operating under suitable software instruction), operable to detect a predetermined misuse event, based on data received from the EVPS.

In this case, the data received from the EVPS is likely to be sensor data from one or more sensors.

Hence more generally, as described herein the diagnostic system may comprise both an electronic vapor provision system (EVPS) and a mobile communication device, wherein the EVPS comprises at least a first sensor and a wireless transmitter, and the mobile communication device comprises a wireless receiver and at least the output processor. In each case for the EVPS and the mobile communication device, the balance of the components of the diagnostic system is located in the other device.

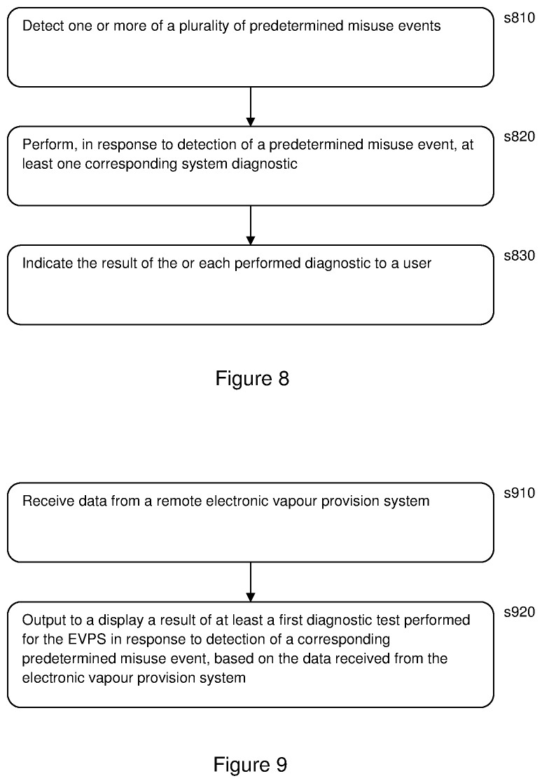

Referring now to FIG. 8, it will be appreciated that the EVPS or a combination of the EVPS and a mobile communication device therefore implement the following diagnostic method for an electronic vapor provision system, comprising the following.

In s810, detecting one or more of a plurality of predetermined misuse events. As described herein, several different misuses may be anticipated, and are detected by comparing signals one or more sensors of the EVPS with predetermined thresholds/ranges, or detecting their presence or absence.

In s820, performing, in response to detection of a predetermined misuse event, at least one corresponding system diagnostic. As described herein, specific misuses have one or more respective corresponding diagnostics.

In s830, indicating the result of the or each performed diagnostic to a user. As described herein, this may be done via a user interface of the EVPS, or of a mobile communication device, or both.

It will be apparent to a person skilled in the art that variations in the above method corresponding to operation of the various embodiments of the apparatus as described and claimed herein are considered within the scope of the present disclosure, including but not limited to:
the EVPS comprising an accelerometer sensor, and the detecting comprising detecting whether a signal from the accelerometer exceeds a threshold value; and if so, the diagnosing comprising performing a circuit integrity test;
the EVPS comprises an electronic thermometer sensor, and the detecting comprising detecting whether a signal from the electronic thermometer exceeds a threshold value; and if so, the diagnosing comprising performing a cell integrity test;
the EVPS comprising at least one of an input voltage sensor and input current sensor, and the detecting comprising detecting whether a signal from at least one of the input voltage and input current detector is outside a predetermined range, and if so, the diagnosing comprising performing a cell integrity test;
the EVPS comprising a payload closure sensor, and the detecting comprising detecting a signal from the payload closure sensor indicating improper payload closure; and if so, the diagnosing comprising performing one or more selected from the list consisting of a moisture test, a circuit integrity test, and a cell integrity test;
the EVPS comprising a moisture sensor, and the detecting comprising detecting a signal from the moisture sensor indicating moisture; and if so, the diagnosing comprising performing one or more selected from the list consisting of a circuit integrity test and a cell integrity test;
transmitting signals from one or more sensors of the EVPS to a remote mobile communication device;
the EVPS conducting the detecting, the EVPS comprising a wireless communications circuit for communication with a remote mobile communication device, the remote mobile communication device conducting at least the diagnosing, and the method comprising transmitting to the remote mobile communication device the output of a respective detection from the detecting; and
the EVPS conducting the diagnosing, the EVPS comprising a wireless communications circuit for communication with a remote mobile communication device, the remote mobile communication device conducting the outputting, and the method comprising transmitting to the remote mobile communication device a result of the or each diagnostic test performed in the diagnosing.

Similarly, referring now to FIG. 8, it will be appreciated that a mobile communication device may implement the following diagnostic method for use with a mobile communications device, comprising the following.

In s910, receiving data from a remote electronic vapor provision system (EVPS).

In s920, outputting to a display a result of at least a first diagnostic test performed for the EVPS in response to detection of a corresponding predetermined misuse event, based on the data received from the EVPS.

Again it will be apparent to a person skilled in the art that variations in the above method corresponding to operation of the various embodiments of the apparatus as described and claimed herein are considered within the scope of the present disclosure, including but not limited to:
performing at least a first diagnostic test for the EVPS in response to detection of a corresponding predetermined misuse event, based on data received from the EVPS; and
detecting a predetermined misuse event, based on data received from the EVPS.

It will be appreciated that the above methods may be carried out on conventional hardware suitably adapted as applicable by software instruction or by the inclusion or substitution of dedicated hardware.

Thus the required adaptation to existing parts of a conventional equivalent device (an EVPS such as an e-cigarette, and optionally a mobile communication device such as a smartphone) may be implemented in the form of a computer program product comprising processor implementable instructions stored on a non-transitory machine-readable medium such as a floppy disk, optical disk, hard disk, PROM, RAM, flash memory or any combination of these or other storage media, or realized in hardware as an ASIC (application specific integrated circuit) or an FPGA (field programmable gate array) or other configurable circuit suitable to use in adapting the conventional equivalent device. Separately, such a computer program may be transmitted via data signals on a network such as an Ethernet, a wireless network, the Internet, or any combination of these or other networks.

1. A diagnostic system for an electronic vapor provision system (EVPS), comprising:
a detection processor adapted to detect one or more of a plurality of predetermined misuse events;
a diagnostic processor adapted to perform, in response to detection of a predetermined misuse event, at least one corresponding system diagnostic; and
an output processor adapted to indicate a result of the at least one system diagnostic performed to a user.

2. The diagnostic system of claim 1, wherein at least one of:
the EVPS comprises an accelerometer sensor, the detection processor is adapted to detect whether a signal from the accelerometer sensor exceeds a threshold value, and if so, the diagnostic processor is adapted to perform a circuit integrity test;
the EVPS comprises an electronic thermometer sensor, the detection processor is adapted to detect whether a signal from the electronic thermometer sensor exceeds a threshold value, and if so, the diagnostic processor is adapted to perform a cell integrity test;
the EVPS comprises at least one of an input voltage sensor or an input current sensor, the detection processor is adapted to detect whether a signal from at least one of the input voltage sensor or the input current sensor is outside a predetermined range, and if so, the diagnostic processor is adapted to perform a cell integrity test;
the EVPS comprises a payload closure sensor, the detection processor is adapted to detect a signal from the payload closure sensor indicating improper payload closure, and if so, the diagnostic processor is adapted to perform one or more selected from the group consisting of: a moisture test, a circuit integrity test, and a cell integrity test; or
the EVPS comprises a moisture sensor, the detection processor is adapted to detect a signal from the moisture sensor indicating moisture, and if so, the diagnostic processor is adapted to perform one or more selected from the group consisting of: a circuit integrity test, and a cell integrity test.

3-6. (canceled)

7. The diagnostic system of claim 1, wherein the EVPS comprises a wireless communications circuit for communication with a remote mobile communication device, the remote mobile communication device comprising at least the detection processor, and signals from one or more sensors of the EVPS are transmitted to the remote mobile communication device.

8. The diagnostic system of claim 1, wherein the EVPS comprises the detection processor;
the EVPS comprises a wireless communications circuit for communication with a remote mobile communication device, the remote mobile communication device comprising at least the diagnostic processor; and
a respective detection by the detection processor is transmitted to the remote mobile communication device.

9. The diagnostic system of claim 1, wherein the EVPS comprises the diagnostic processor;
the EVPS comprises a wireless communications circuit for communication with a remote mobile communication device, the remote mobile communication device comprising the output processor; and
a result of the at least one system diagnostic performed is transmitted to the remote mobile communication device.

10. A mobile communication device, comprising:
a wireless communications circuit for communication with a remote electronic vapor provision system (EVPS);
a display; and
an output processor operable to output to the display a result of at least a first diagnostic test performed for the EVPS in response to detection of a corresponding predetermined misuse event, based on data received from the EVPS.

11. The mobile communication device of claim 10, further comprising:
a diagnostic processor operable to perform at least the first diagnostic test for the EVPS in response to detection of a corresponding predetermined misuse event, based on data received from the EVPS.

12. The mobile communication device of claim 11, comprising:
a detection processor operable to detect a predetermined misuse event, based on data received from the EVPS.

13. The diagnostic system of claim 1, comprising
the electronic vapor provision system (EVPS); and
a mobile communication device;
wherein the EVPS comprises at least a first sensor and a wireless transmitter, and the mobile communication device comprises a wireless receiver and the output processor.

14. A diagnostic method for an electronic vapor provision system (EVPS), comprising:
detecting one or more of a plurality of predetermined misuse events;
performing, in response to the detection of one or more of the plurality of predetermined misuse events, at least one corresponding system diagnostic; and
indicating a result of the at least one system diagnostic performed to a user.

15. The diagnostic method of claim 14, wherein at least one of:
the EVPS comprises an accelerometer sensor, the detecting comprises detecting whether a signal from the accelerometer sensor exceeds a threshold value, and if so, the performing comprises performing a circuit integrity test;
the EVPS comprises an electronic thermometer sensor, the detecting comprises detecting whether a signal from the electronic thermometer sensor exceeds a threshold value, and if so, the performing comprises performing a cell integrity test;
the EVPS comprises at least one of an input voltage sensor or an input current sensor, the detecting comprises detecting whether a signal from at least one of the input voltage sensor or the input current sensor is outside a predetermined range, and if so, the performing comprises performing a cell integrity test;
the EVPS comprises a payload closure sensor, the detecting comprises detecting a signal from the payload closure sensor indicating improper payload closure, and if so, the performing comprises performing one or more selected from the group consisting of: a moisture test, a circuit integrity test, and a cell integrity test; or
the EVPS comprises a moisture sensor, the performing comprises detecting a signal from the moisture sensor indicating moisture, and if so, the performing comprises performing one or more selected from the group consisting of: a circuit integrity test, and a cell integrity test.

16-19. (canceled)

20. The diagnostic method of claim 14, further comprising transmitting signals from one or more sensors of the EVPS to a remote mobile communication device.

21. The diagnostic method of claim 14, wherein:
the EVPS conducts the detecting;
the EVPS comprises a wireless communications circuit for communication with a remote mobile communication device, the remote mobile communication device conducting at least the performing; and
the method further comprising:
transmitting to the remote mobile communication device an output of the detecting.

22. The diagnostic method of claim 14, wherein:
the EVPS conducts the performing;
the EVPS comprises a wireless communications circuit for communication with a remote mobile communication device, the remote mobile communication device conducting the indicating; and
the method further comprising transmitting to the remote mobile communication device a result of the at least one system diagnostic performed.

23. A diagnostic method for use with a mobile communications device, comprising:
receiving data from a remote electronic vapor provision system (EVPS); and
outputting to a display a result of at least a first diagnostic test performed for the EVPS in response to detection of a corresponding predetermined misuse event, based on the data received from the EVPS.

24. The diagnostic method of claim 23, further comprising:
performing at least the first diagnostic test for the EVPS in response to the detection of a corresponding predetermined misuse event, based on the data received from the EVPS.

25. The diagnostic method of claim 24, further comprising:
detecting the predetermined misuse event, based on the data received from the EVPS.

26. A non-transitory computer readable storage medium storing computer executable instructions adapted to cause a computer system to, when executed by the computer, perform the method of claim 14.
